(19) United States
(12) Patent Application Publication
(10) Pub. No.: US 2019/0064557 A1
(43) Pub. Date: Feb. 28, 2019

(54) OPTICAL DEVICE AND DISPLAY DEVICE

(71) Applicant: FUJIFILM Corporation, Tokyo (JP)

(72) Inventor: Yujiro YANAI, Minamiashigara-shi (JP)

(73) Assignee: FUJIFILM Corporation, Tokyo (JP)

(21) Appl. No.: 16/171,090

(22) Filed: Oct. 25, 2018

Related U.S. Application Data
(63) Continuation of application No. PCT/JP2017/015221, filed on Apr. 14, 2017.

(30) Foreign Application Priority Data
May 20, 2016 (JP) 2016-101961

(51) Int. Cl. G02F 1/13; G02F 1/1335; G02F 1/1347; G02F 1/13363

(52) U.S. Cl. CPC G02F 1/1323; G02F 1/133617; G02F 1/1347; G02F 1/13725; G02F 2201/44; G02F 2203/05; G02F 1/13363

(57) ABSTRACT

An optical device includes a first composite film; a second composite film or a polarizing film; a λ/2 plate; and a light-emitting unit, in which the first composite film and the second composite film contains a liquid crystal compound aligned in a thickness direction and a photochromic material, optical characteristics of the photochromic material are changed by irradiation with light, a light transmittance in the thickness direction becomes smaller than a light transmittance in a direction orthogonal to the thickness direction, the polarizing film has an absorption axis in the thickness direction, and the light-emitting unit emits light that changes the optical characteristics of the photochromic material.

### CROSS-REFERENCE TO RELATED APPLICATIONS

This application is a Continuation of PCT International Application No. PCT/JP2017/015221, filed on Apr. 14, 2017, which claims priority under 35 U.S.C. § 119(a) to Japanese Patent Application No. 2016-101961, filed on May 20, 2016. Each of the above application(s) is hereby expressly incorporated by reference, in its entirety, into the present application.

### BACKGROUND OF THE INVENTION

### 1. Field of the Invention

The present invention relates to an optical device used for a display device such as a liquid crystal display device and a display device using this optical device.

### 2. Description of the Related Art

In personal electronic devices, for example, tablet personal computers (PCs), notebook PCs, and mobile phones such as smartphones, there is a demand that users do not want their screens to be peeped by the surrounding third parties. Therefore, in these electronic devices, it has been attempted to narrow the viewing angle of a screen such that the surrounding third parties cannot peep at the screen.

For example, JP2008-165201A describes an optical film which includes a polarizing film on both surfaces of a retardation film such as a λ/2 plate and in which this polarizing film includes a polarizer, and an absorption axis of the polarizer is aligned in a direction substantially perpendicular to the film surface.

Since the polarizing film in this optical film has an absorption axis aligned in a direction substantially perpendicular to the film surface, incidence rays from an oblique direction with respect to the film surface can be drastically reduced. Therefore, the viewing angle of a display image can be narrowed by placing this optical film on a screen of a plasma display or a liquid crystal display to make a light shielding area using the oblique direction.

Meanwhile, in a case where this optical film is placed on the screen, the optical film is fixed thereto in a state in which the viewing angle from the oblique direction is narrow. Accordingly, in a case where an image is displayed again at a typical wide viewing angle, the optical film needs to be removed.

In other words, in a case of using this optical film, it is necessary that the optical film is detached from or attached onto the screen in order to switch between image display at a typical wide viewing angle and image display at a narrow viewing angle.

In addition, various display devices which are capable of switching between image display at a typical wide viewing angle and image display at a narrow viewing angle in order to ensure the security for preventing peeping from the side and to realize sufficient visibility from the side as necessary in electronic devices such as tablet PCs or notebook PCs have been suggested.

For example, JP2007-178979A discloses a liquid crystal display device including a first substrate which includes a gate wiring and a data wiring corresponding to red (R), green (G), blue (B), and white (W) subpixels; a thin film transistor which is disposed at the intersection of the gate wiring and the data wiring; a plate type first common electrode which is comprised in R, G, B, and W subpixels; a pixel electrode which is connected to the thin film transistor, is insulated from the first common electrode, and has a plurality of slits; a second substrate which is bonded to the first substrate in a state of facing the first substrate and comprises a liquid crystal layer in a space between the first substrate and the second substrate; and a plate type second common electrode which is formed on the second substrate so as to correspond to the W subpixel.

In a case of image display at a wide viewing angle in this liquid crystal display device, the W subpixel is driven in a fringe field switching (FFS) mode similar to the subpixels adjacent to R, G, and B subpixels so that the viewing angle is widened, and the W luminance is also compensated. In a case of image display at a narrow viewing angle, the W subpixel is driven in an electrically controlled birefringence (ECB) mode that enables formation of a vertical electric field, which is different from the subpixels adjacent to R, G, and B subpixels, and thus the viewing angle can be decreased.

Further, JP2004-279866A discloses a display device including a screen which has a viewing angle limited to one dimension direction; and image display switching means which switches between a personal view mode in which an erecting direction of an image to be displayed on this screen is substantially orthogonal to a limiting direction of the viewing angle and a multi view mode in which the erecting direction of the image coincides with the limiting direction of the viewing angle.

In other words, in this display device, it is possible to switch between image display at a wide viewing angle and image display at a narrow viewing angle depending on whether the top and the bottom of the image coincide with the limiting direction of the viewing angle or not by limiting the viewing angle of the screen to one dimension direction using a microprism sheet or the like and by rotating the image by 90°.

### SUMMARY OF THE INVENTION

According to the display devices described in JP2007-178979A and JP2004-279866A, it is possible to switch between image display at a typical wide viewing angle and image display at a narrow viewing angle using one display device without attaching or detaching any member.

However, in the liquid crystal display device of JP2007-178979A, the configuration of the display device becomes complicated because the liquid crystal display element needs to have a special structure with W subpixels, a plurality of substrates, and a plurality of common electrodes and the liquid crystal display device needs to be driven in different modes.

Further, in the display device of JP2004-279866A, extra image processing becomes necessary since the image needs to rotate by 90° in order to switch between display at a wide viewing angle and display at a narrow viewing angle. Further, since the aspect ratio of a screen varies in a typical display device, the aspect ratios of an image vary between display at a wide viewing angle and display at a narrow viewing angle in this display device.

An object of the present invention is to solve the above-described problems of the related art and to provide an optical device which has a simple configuration and is capable of switching between image display at a typical wide viewing angle and image display at a narrow viewing angle obtained by limiting the viewing angle with a simple operation without performing detachment and attachment of a member nor performing image processing by being used in a tablet PC or a notebook PC; and a display device obtained by using this optical device.

In order to achieve the above-described object, according to the present invention, there is provided an optical device comprising: a first composite film; a second composite film or a polarizing film; a λ/2 plate which is disposed between the first composite film and the second composite film or the polarizing film; and a light-emitting unit, in which the first composite film and the second composite film contain a liquid crystal compound aligned in a thickness direction and a photochromic material, optical characteristics of the photochromic material are changed by irradiation with light, a light transmittance of the first composite film and the second composite film in the thickness direction becomes smaller than a light transmittance in a direction orthogonal to the thickness direction, the polarizing film has an absorption axis in the thickness direction, and the light-emitting unit emits light that changes the optical characteristics of the photochromic material to the first composite film or to the first composite film and the second composite film.

In the optical device of the present invention, it is preferable that the polarizing film has a structure in which a birefringent material is aligned in the thickness direction.

Further, it is preferable that the birefringent material is a dichroic coloring agent.

Further, it is preferable that the light-emitting unit emits ultraviolet rays.

According to the present invention, there is provided a display device comprising: a display element; and the optical device of the present invention.

In the display device of the present invention, it is preferable that the display element is a liquid crystal display element.

Further, it is preferable that the light-emitting unit of the optical device constitutes a backlight unit for allowing the liquid crystal display element to display an image.

The optical device of the present invention has a simple configuration and is capable of switching between image display at a typical wide viewing angle and image display at a narrow viewing angle obtained by limiting the viewing angle, by being combined with a tablet PC or a notebook PC with a simple operation without performing detachment and attachment of a member. Further, the display device of the present invention is capable of switching between image display at a typical wide viewing angle and image display at a narrow viewing angle obtained by limiting the viewing angle, by utilizing the optical device of the present invention with a simple configuration and a simple operation without performing detachment and attachment of a member.

### BRIEF DESCRIPTION OF THE DRAWINGS

FIG. 1 is a view conceptually illustrating an example of an optical device of the present invention.

FIG. 2 is a conceptual view for describing a configuration of the optical device illustrated in FIG. 1.

FIG. 3 is a conceptual view for describing an action of the optical device illustrated in FIG. 1.

FIG. 4 is a conceptual view for describing the action of the optical device illustrated in FIG. 1.

FIG. 5 is a view conceptually illustrating another example of the optical device of the present invention.

### DESCRIPTION OF THE PREFERRED EMBODIMENTS

Hereinafter, an optical device and a display device according to the embodiment of the present invention will be described in detail based on preferred examples illustrated in the accompanying drawings.

Further, the numerical ranges shown using “to” in the present specification indicate ranges including the numerical values described before and after “to” as the lower limits and the upper limits.

In the present specification, the concept of “the same” includes a typically acceptable error range in the technical field. Further, in the present specification, the concept of “all”, “any”, or “the entire surface” includes a typically acceptable error range in the technical field, for example, a case of 99% or greater, 95% or greater, or 90% or greater in addition to a case of 100%.

In the present specification, Re (λ) represents an in-plane retardation at a wavelength λ. The wavelength λ is set to 550 nm unless otherwise specified.

In the present specification, Re (λ) represents a value measured at the wavelength λ using AxoScan OPMF-1 (manufactured by OPTO SCIENCE, INC.). A slow axis direction(°) is calculated by inputting an average refractive index ((Nx+Ny+Nz)/3) and a film thickness (d (μm)) in AxoScan based on “Re (λ)=R0 (λ)”.

In addition, R0 (λ) represents a numerical value calculated by AxoScan and indicates Re (λ).

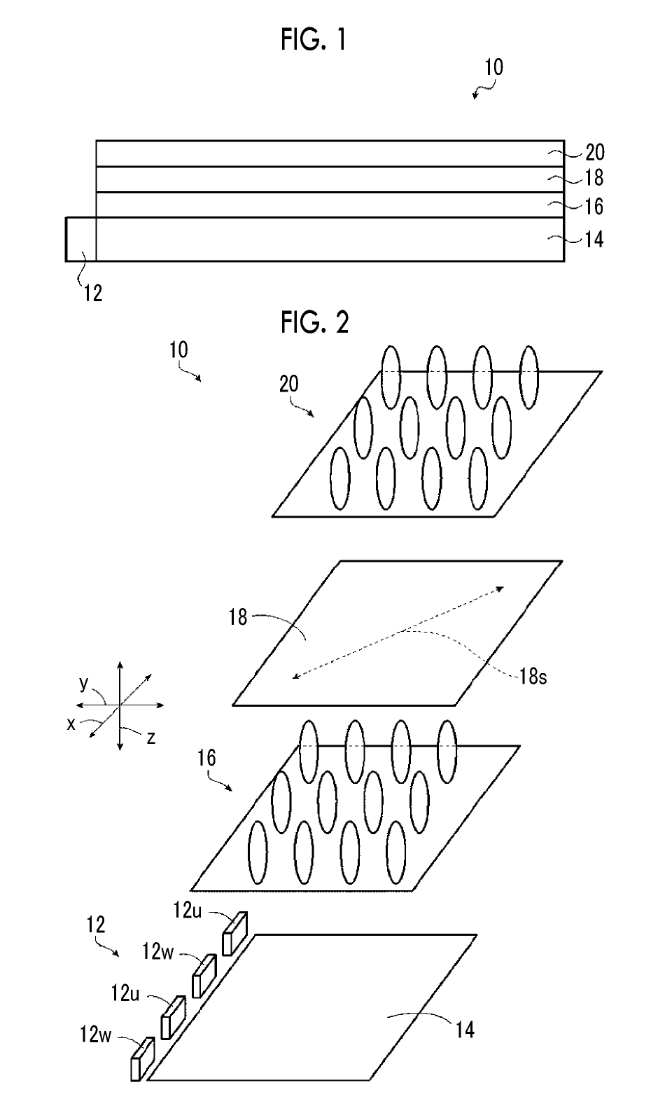

FIGS. 1 and 2 conceptually illustrate an example of an optical device according to the embodiment of the present invention.

As illustrated in FIGS. 1 and 2, an optical device 10 includes a light source unit 12, a light guide plate 14, a first composite film 16, a λ/2 plate 18, and a second composite film 20. In the example illustrated in the figures, the light source unit 12 and the light guide plate 14 constitute a light-emitting unit of the present invention which emits light that changes the optical characteristics of a photochromic material of the first composite film 16 and the second composite film 20.

Further, the light guide plate 14 and the first composite film 16, the first composite film 16 and the λ/2 plate 18, and the λ/2 plate 18 and the second composite film 20 may be spaced from each other, laminated on each other, or bonded to each other using an optical clear adhesive (OCA), optical transparent double-sided tape, an optical transparent pressure sensitive sheet, and a pressure sensitive adhesive or an adhesive such as an ultraviolet curable resin, used for bonding a sheet-like material with an optical device and an optical element.

In addition, the positional relationship between the first composite film 16 and the second composite film 20 is not limited to the configuration illustrated in FIGS. 1 and 2. In other words, the position of the first composite film 16 and the position of the second composite film 20 may be reversed so that the second composite film 20 is disposed between the light guide plate 14 and the λ/2 plate 18 and the first composite film 16 is disposed on a side of the λ/2 plate 18 opposite to a side where the second composite film 20 is provided.

FIGS. 1 and 2 also conceptually illustrate a portion of the display device according to the embodiment of the present invention which is formed by using the optical device 10. FIGS. 1 and 2 illustrate an example in which the optical device 10 is used as a liquid crystal display device. In the description below, the liquid crystal display device is also referred to as an LCD (liquid crystal display).

In other words, the light source unit 12 and the light guide plate 14 serve as a light-emitting unit in the optical device 10 and also serve as a backlight unit of the LCD.

Further, various known members, included in a typical LCD, such as a polarizing plate on a backlight side (rear surface side) of an LCD; a liquid crystal display element (liquid crystal display panel) having a thin film transistor, a liquid crystal cell, and the like; a polarizing plate on a front surface side; and light diffusion means such as a prism sheet are disposed on the upper side of the second composite film 20 in the figure. In addition to the exemplified these members, various known members included in a known LCD may be also provided.

The light source unit 12 may be formed by arranging a plurality of light sources in one direction.

As illustrated in FIG. 2, the light source unit 12 has a configuration in which white light sources 12w and ultraviolet (UV) light sources 12u are alternately arranged. The white light source 12w is a light source emitting white light, which becomes a backlight for allowing an LCD to perform image display. The UV light source 12u is a light source emitting ultraviolet light (UV light), which changes the optical characteristics of the photochromic material of the first composite film 16 and the second composite film 20 described below.

Further, FIG. 2 illustrates only four light sources, but the present invention is not limited thereto. In addition, the light source unit 12 is formed by alternately arranging the white light sources 12w and the UV light sources 12u, but the present invention is not limited thereto.

In other words, the number of white light sources 12w may be set to any number as long as the white light sources 12w can emit a sufficient quantity of light for displaying an image using an LCD and the number of UV light sources 12u may be set to any number as long as the UV light sources 12u can emit a sufficient quantity of light for changing the optical characteristics of the photochromic material of the first composite film 16 and the second composite film 20 described below. Therefore, various configurations can be used as the arrangement of the white light sources 12w and the UV light sources 12u, for example, one UV light source 12u with respect to three white light sources 12w or one UV light source 12u with respect to six white light sources 12w.

In order to make the light quantity of the backlight uniform over the entire surface, it is preferable that the white light sources 12w are evenly arranged in the arrangement direction. Similarly, in order to properly change the optical characteristics of the photochromic material of the first composite film 16 and the second composite film 20 over the entire surface, it is preferable that the UV light sources 12u are evenly arranged in the arrangement direction.

As the white light source 12w, various light sources serving as a backlight of an LCD can be used. In addition, as the UV light source 12u, various light sources capable of emitting light that changes the optical characteristics of the photochromic material of the first composite film 16 and the second composite film 20 can be used. The light that changes the optical characteristics of the photochromic material is not limited to ultraviolet light, and various light (light sources) that changes the optical characteristics of the photochromic material can be used according to the photochromic material to be used.

Accordingly, various known light sources can be used as the white light source 12w and the UV light source 12u as long as the light sources are capable of emitting light having a required wavelength (wavelength range), for example, a light emitting diode (LED), various lasers such as a semiconductor laser, and a fluorescent lamp.

As the white light source 12w, that is, the light source serving as a backlight of an LCD, a light source emitting light that does not have a wavelength (component) changing the optical characteristics of the photochromic material is preferable. Alternatively, even in a case where the white light source 12w emits light having a wavelength of changing the optical characteristics of the photochromic material, it is preferable that the light quantity is insufficient for changing the optical characteristics of the photochromic material.

In the present invention, the light source unit is not limited to the configuration in which a plurality of light sources are arranged in one direction as the example illustrated in the figure.

In other words, in the present invention, a linear light source such as a fluorescent lamp or a light source obtained by arranging a plurality of LEDs may be used as the light source. Alternatively, for example, the light source emitting light serving as a backlight is a linear light source, and the light source emitting light that changes the optical characteristics of the photochromic material may have a configuration in which a plurality of light sources are arranged in the longitudinal direction of the linear light sources for a backlight.

The light guide plate 14 is a typical light guide plate used as a backlight unit of an LCD.

Accordingly, various known light guide plates used as a backlight unit of an LCD are all available to be used as the light guide plate 14.

The first composite film 16 contains a liquid crystal compound aligned in the thickness direction and a photochromic material. Further, it is preferable that the photochromic material is positioned between the liquid crystal compounds (contained between the liquid crystal compounds).

The second composite film 20 is the same as the first composite film 16 and contains a liquid crystal compound aligned in the thickness direction and a photochromic material. Even in the second composite film 20, it is preferable that the photochromic material is positioned between the liquid crystal compounds (contained between the liquid crystal compounds).

In a case where the UV light sources 12u are switched off, the first composite film 16 and the second composite film 20 are in a state of not functioning, and do not act on light. In other words, in the case where the UV light sources 12u are switched off in the optical device 10 (LCD), the light emitted from the light guide plate 14 is simply transmitted through the first composite film 16, and the light transmitted through the λ/2 plate 18 described below is simply transmitted through the second composite film 20.

On the contrary, in a case where the UV light sources 12u are switched on, the optical characteristics of the photochromic material of the first composite film 16 and the second composite film 20 are changed by ultraviolet light, and the light transmittance in the thickness direction becomes smaller than the light transmittance in a direction orthogonal to the thickness direction. In other words, in the case where the UV light sources 12u are switched on, the optical characteristics of the photochromic material of the first composite film 16 and the second composite film 20 are changed, and the first composite film 16 and the second composite film 20 enter the same state as the state of a polarizing plate having an absorption axis in the thickness direction, that is, a direction that coincides with the alignment direction of the liquid crystal compound.

Although described below, the optical device (display device) has a configuration in which the λ/2 plate 18 is interposed between the first composite film 16 and the second composite film 20 and includes the light guide plate 14 and the UV light sources 12u emitting ultraviolet light that changes the optical characteristics of the photochromic material. Therefore, it is possible to switch image display at a typical wide viewing angle and image display at a narrow viewing angle in an LCD by switching off or switching on the UV light sources 12u.

This point will be described below.

In the present invention, the expression “the liquid crystal compound of the first composite film 16 and the second composite film 20 is aligned in the thickness direction” means that the liquid crystal compound is aligned at an angle of 80° to 90° with respect to the film surface (the main surface (maximum surface)) of each composite film. Further, in the first composite film 16 and the second composite film 20, the liquid crystal compound is aligned preferably at an angle of 85° to 90° and most preferably perpendicularly (90°) to the film surface of each composite film.

In the present invention, in a case where the liquid crystal compound is a rod-like liquid crystal compound, the expression “the liquid crystal compound is aligned in the thickness direction” means that the direction of a director of a rod-like liquid crystal compound is a direction perpendicular to the film surfaces of the first composite film 16 and the second composite film 20. Further, in a case where the liquid crystal compound is a discotic liquid crystal compound, the expression means that the direction of a normal line of a disc plane of a discotic liquid crystal compound is horizontal to the film surfaces of the first composite film 16 and the second composite film 20.

The alignment of the liquid crystal compound in the thickness direction can be confirmed by observing the cross sections of the first composite film 16 and the second composite film 20 using a transmission electron microscope (TEM).

In the first composite film 16 and the second composite film 20, the absorption axis in a state in which the UV light sources 12u are switched on is in the thickness direction which is the same as the alignment direction of the liquid crystal compound, in other words, the absorption axis is at an angle of 80° to 90° with respect to the film surface of each composite film. Further, in the first composite film 16 and the second composite film 20, the absorption axis in a state in which the UV light sources 12u are switched on is preferably at an angle of 85° to 90° and most preferably perpendicularly (90°) to the film surface of each composite film.

As an example, the first composite film 16 can be prepared by coating a base material that has an alignment film on a surface thereof with a composition containing at least a liquid crystal compound and a photochromic material, vertically aligning the liquid crystal compound according to a guest-host method, and curing the liquid crystal compound to form a layer in which the molecules of the liquid crystal compound are fixed in a substantially vertically aligned state.

As an example, similar to the first composite film 16, the second composite film 20 can also be prepared by coating a base material that has an alignment film on a surface thereof with a composition containing at least a liquid crystal compound and a photochromic material, vertically aligning the liquid crystal compound according to a guest-host method, and curing the liquid crystal compound to form a layer in which the molecules of the liquid crystal compound are fixed in a substantially vertically aligned state.

In other words, as an example, the first composite film 16 and the second composite film 20 are formed using a base material having an alignment film and a layer formed by curing a liquid crystal composition.

Specifically, the first composite film 16 and the second composite film 20 can be prepared in the same manner as a liquid crystal film formed by coating a base material having an alignment film on a surface thereof with a liquid crystal composition containing at least a liquid crystal compound, curing the composition, and fixing the molecules of the liquid crystal compound in a substantially vertically aligned state.

In the preparation of this liquid crystal film, a liquid crystal coated film is formed by coating a base material used for forming an alignment film with a liquid crystal composition containing at least a liquid crystal compound, a solvent, and an aligning agent or the like as necessary and drying the composition. Accordingly, the first composite film 16 and the second composite film 20 may be prepared using a liquid crystal composition obtained by further adding a photochromic material to the liquid crystal composition used for preparing the liquid crystal film.

Base Material

The shape, the structure, the size, or the like of the base material used for the first composite film 16 and the second composite film 20 is not particularly limited and can be appropriately selected according to the purpose thereof. Examples of the shape thereof include a flat plate shape and a sheet shape. Further, examples of the structure thereof include a single layer structure and a laminated structure, and the structure thereof can be appropriately selected.

The material of the base material is not particularly limited, and any of an inorganic material or an organic material can be suitably used.

Examples of the inorganic material include glass, quartz, and silicon.

Examples of the organic material include an acetate-based resin such as triacetyl cellulose (TAC), a polyester-based resin, a polyether sulfone-based resin, a polysulfone-based resin, a polycarbonate-based resin, a polyamide-based resin, a polyimide-based resin, a polyolefin-based resin, an acrylic resin, a polynorbornene-based resin, a cellulose-based resin, a polyarylate-based resin, a polystyrene-based resin, a polyvinyl alcohol-based resin, a polyvinyl chloride-based resin, a polyvinylidene chloride-based resin, and a polyacrylic resin. These may be used alone or in combination of two or more kinds thereof.

The base material may be appropriately synthesized or a commercially available product may be used as the base material.

The thickness of the base material is not particularly limited and can be appropriately selected according to the purpose thereof In addition, the thickness thereof is preferably in a range of 10 to 500 μm and more preferably in a range of 50 to 300 μm.

Alignment Film

As an example, the alignment film used for the first composite film 16 and the second composite film 20 is a film of a cured product, such as polyimide, polyamide imide, polyether imide, polyvinyl alcohol, or an acrylate monomer, which is laminated on the surface of the base material.

Further, the alignment film may be subjected to a photoalignment treatment. This photoalignment is used for generating anisotropy on a surface of a photoalignment film by irradiating photoactive molecules of an azobenzene-based polymer, polyvinyl cinnamate, or the like with linearly polarized light or obliquely unpolarized light having a wavelength that allows the photoactive molecules to cause a photochemical reaction. As the result, alignment of a molecular long axis of the outermost surface of the film is generated by incidence rays and the driving force that aligns liquid crystals in contact with the molecules of this outermost surface is formed.

Further, as the material of the photoalignment film, a material that generates anisotropy on the film surface using any reaction from among photoisomerization, photodimerization, photocyclization, photocrosslinking, photodecomposition, and photodecomposition-bonding, obtained by irradiating photoactive molecules with linearly polarized light having a wavelength that allows the photoactive molecules to cause a photochemical reaction, may be used, and examples thereof include various materials of photoalignment films which are described in “The Japanese Liquid Crystal Society, Masaki Hasegawa, Vol. 3, No. 1, p. 3 (1999)” and “The Japanese Liquid Crystal Society, Yasumasa Takeuchi, Vol. 3, No. 4, p. 262 (1999)”.

In a case where such an alignment film is coated with a liquid crystal composition, liquid crystals are aligned using at least any of fine grooves on the surface of the alignment film or molecule alignment on the outermost surface as the driving force.

Liquid Crystal Composition for Forming First Composite Film 16 and Second Composite Film 20

<Liquid Crystal Compound>

The liquid crystal compound used for the liquid crystal composition for forming the first composite film 16 and the second composite film 20 is not particularly limited as long as the compound contains a polymerizable group and is cured by irradiation with ultraviolet rays, and suitable examples thereof include compounds represented by the following structural formula.

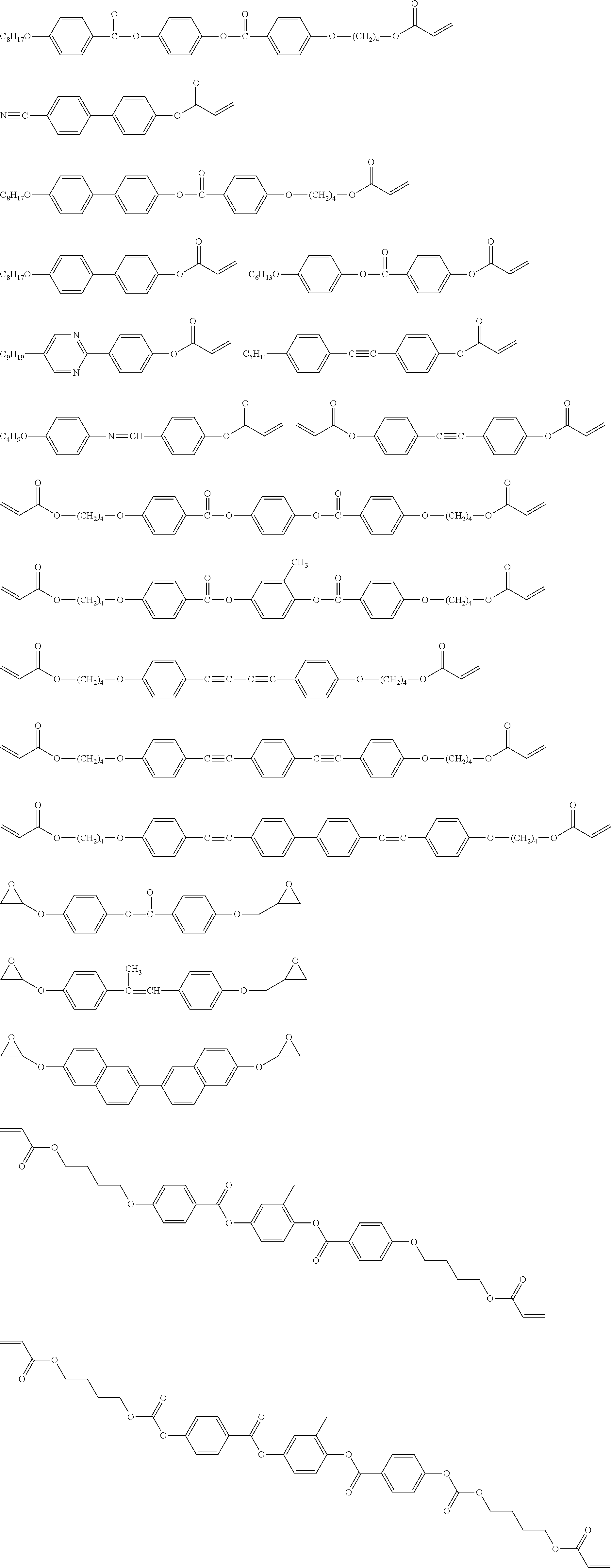

A commercially available product can be used as such a liquid crystal compound. Examples of the commercially available product include PALIOCOLOR LC242 (trade name, manufactured by BASF SE); E7 (trade name, manufactured by Merck KGaA); LC-Silicon-CC3767 (trade name, manufactured by Wacker Chemie AG); L35, L42, L55, L59, L63, L79, and L83 (all trade names, manufactured by Takasago International Corporation).

The content of the liquid crystal compound is preferably in a range of 10% to 90% by mass and more preferably in a range of 20% to 80% by mass with respect to the total solid content of the liquid crystal composition.

<Air Interface Vertical Aligning Agent>

As described above, the first composite film 16 and the second composite film 20 contain a photochromic material and a liquid crystal compound aligning in the thickness direction, and in the case where the UV light sources 12u are switched on, the optical characteristics of the photochromic material are changed by ultraviolet light so that the first composite film 16 and the second composite film 20 enter the same state as the state of a polarizing plate having an absorption axis in the thickness direction, that is, a direction that coincides with the alignment direction of the liquid crystal compound.

For this, a liquid crystal layer (liquid crystal compound) which is a medium is aligned in the thickness direction. The liquid crystal layer formed on the alignment film provided on one surface of the base material is substantially vertically aligned in some cases from the alignment film side to the air interface side by adjusting the terminal thereof to be hydrophobic. However, in this state, the liquid crystal layer is obliquely distorted in the air interface. Therefore, the liquid crystal layer is more stably aligned in the thickness direction by adding the air interface vertical aligning agent to the liquid crystal composition for forming the first composite film 16 and the second composite film 20.

The air interface vertical aligning agent is not particularly limited and can be appropriately selected according to the purpose thereof. In addition, the air interface vertical aligning agent can be used by being appropriately selected from the compounds described in paragraphs <0110> to <0194> of JP2006-301605A.

Further, the air interface vertical aligning agent can be used by being selected from polymeric surfactants having a strong interaction with the liquid crystal layer to be used, and suitable examples thereof include MEGAFACE F780F (manufactured by DIC Corporation).

The content of the air interface vertical aligning agent is preferably in a range of 0.01% by mass to 5.0% by mass and more preferably in a range of 0.05% by mass to 3.0% by mass with respect to the total solid content of the liquid crystal composition.

<Photopolymerization Initiator>

It is preferable that the liquid crystal composition for forming the first composite film 16 and the second composite film 20 contains a photopolymerization initiator. The photopolymerization initiator is not particularly limited and can be appropriately selected from known initiators according to the purpose thereof. Examples thereof include p-methoxyphenyl-2,4-bis(trichloromethyl)-s-triazine, 2-(p-butoxystyryl)-5-trichloromethyl 1,3,4-oxadiazole, 9-phenylacridine, 9,10-dimethylbenzphenazine, benzophenone/Michler's ketone, hexaarylbiimidazole/mercaptobenzimidazole, benzyl dimethyl ketal, and thioxanthone/amine. These may be used alone or in combination of two or more kinds thereof.

As these photopolymerization initiators, commercially available products can be used. Examples of the commercially available products include IRGACURE 907, IRGACURE 369, IRGACURE 784, IRGACURE 814, and LUCIRIN TPO (all trade names, manufactured by BASF SE).

The amount of the photopolymerization initiator to be added is preferably in a range of 0.1% to 20% by mass and more preferably in a range of 0.5% to 5% by mass with respect to the mass of the total solid content in the liquid crystal composition.

<Solvent>

The solvent used in the liquid crystal composition for forming the first composite film 16 and the second composite film 20 is not particularly limited and can be appropriately selected according to the purpose thereof. Examples of the solvent include halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, methoxybenzene, and 1,2-dimethoxybenzene; a ketone-based solvent such as acetone, methyl ethyl ketone (MEK), methyl isobutyl ketone, cyclohexanone, cyclopentanone, 2-pyrrolidone, or N-methyl-2-pyrrolidone; an ester-based solvent such as ethyl acetate or butyl acetate; an alcohol-based solvent such as t-butyl alcohol, glycerin, ethylene glycol, triethylene glycol, ethylene glycol monomethyl ether, diethylene glycol dimethyl ether, propylene glycol, dipropylene glycol, or 2-methyl-2,4-pentadiol; an amide-based solvent such as dimethylformamide or dimethylacetamide; a nitrile-based solvent such as acetonitrile or butyronitrile; an ether-based solvent such as diethyl ether, dibutyl ether, tetrahydrofuran, or dioxane; and carbon disulfide, ethyl cellosolve, and butyl cellosolve. These may be used alone or in combination of two or more kinds thereof.

<Photochromic Material>

The photochromic material used in the liquid crystal composition for forming the first composite film 16 and the second composite film 20 is not particularly limited, and various known photochromic materials can be used.

Examples of the photochromic material include those described in paragraphs <0089> to <0339> of US2005/0012998A1, but the present invention is not limited thereto.

The content of the photochromic material is preferably in a range of 3% to 30% by mass, more preferably in a range of 5% to 20% by mass, and still more preferably in a range of 8% to 15% by mass with respect to the total solid content in the liquid crystal composition.

The base material (alignment film) can be coated with the liquid crystal composition for forming the first composite film 16 and the second composite film 20 according to a known coating method. Examples of the coating method include a spin coating method, a cast method, a roll coating method, a flow coating method, a printing method, a dip coating method, a casting film forming method, a bar coating method, and a gravure printing method.

As the method of curing the liquid crystal composition for forming the first composite film 16 and the second composite film 20, heat curing or light curing may be employed, but light curing is particularly preferable.

In the present invention, the first composite film 16 and the second composite film 20 are not limited to the configuration having a base material, and various configurations can be employed. For example, a configuration obtained by using the light guide plate 14 as a surface on which the first composite film 16 and the second composite film 20 are formed, forming an alignment film on a surface of the light guide plate 14, coating the surface with the liquid crystal composition for forming the first composite film 16 and the second composite film 20, and curing the composition may be used.

The λ/2 plate 18 is a known λ/2 plate.

As described above, the λ/2 plate 18 is disposed in a state of being interposed between the first composite film 16 and the second composite film 20 in the optical device 10.

The λ/2 plate (a plate having a λ/2 function) indicates a plate whose in-plane retardation Re (λ) at a specific wavelength λ nm satisfies “Re (λ)=λ/2”. This equation may be satisfied at any wavelength (for example, 550 nm) in a visible light range.

In the λ/2 plate 18, the in-plane retardation Re (550) at a wavelength of 550 nm is not particularly limited, but is preferably in a range of 255 to 295 nm, more preferably in a range of 260 to 290 nm, and still more preferably in a range of 265 to 285 nm.

Further, the broken line on the λ/2 plate 18 illustrated in the figure indicates a slow axis 18s of the λ/2 plate 18.

In the optical device 10 (LCD), the slow axis 18s of the λ/2 plate 18 has an angle of 45° with respect to the vertical direction (x direction) and the horizontal direction (y direction) in the LCD described below.

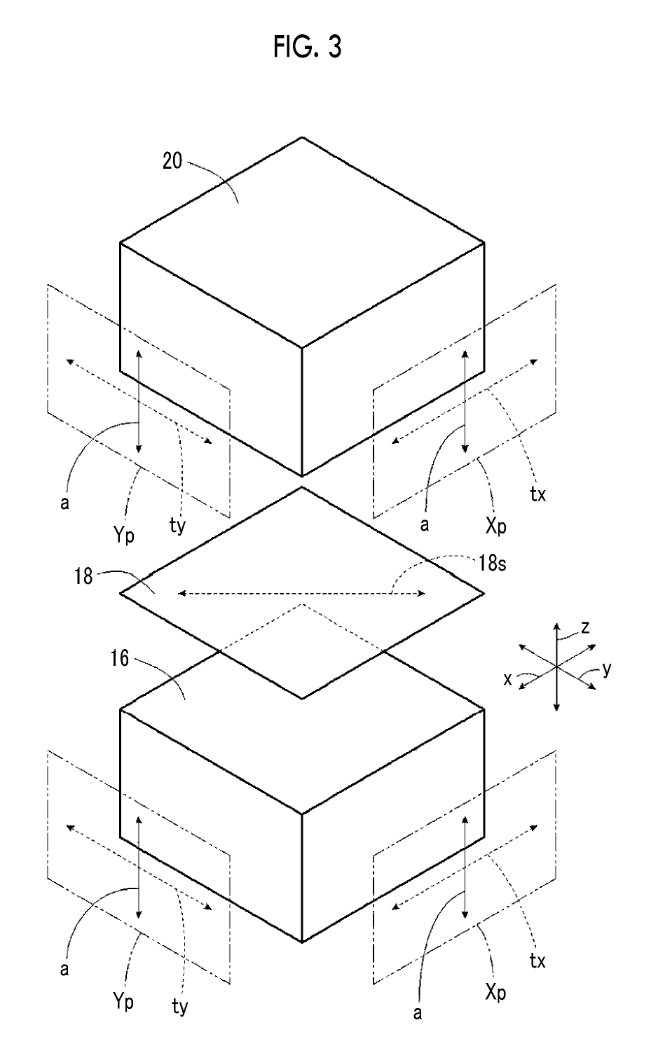

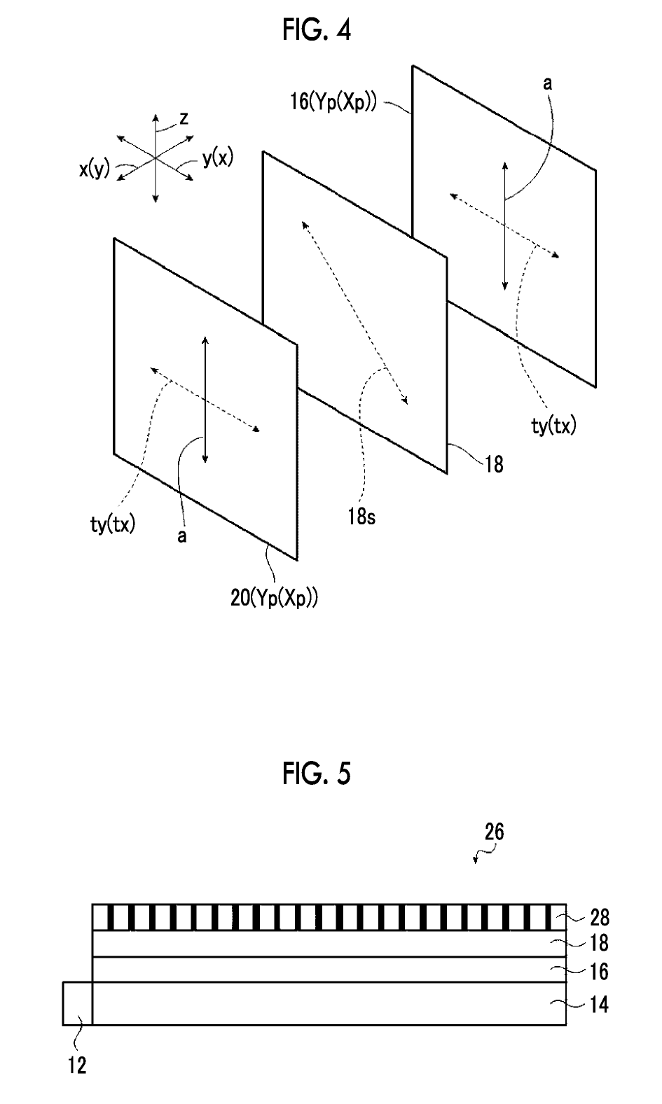

Hereinafter, the optical device 10 and the LCD (display device) will be described in detail by describing the action of the optical device 10 with reference to the conceptual views of FIGS. 3 and 4 in addition to FIGS. 1 and 2.

In the description below, for convenience, the vertical direction in the display of the LCD, that is, the top and bottom direction of the display is set as an x direction, the horizontal direction orthogonal to the x direction is set as a y direction, and the thickness direction of the first composite film 16 and the second composite film 20 orthogonal to the x direction and y direction is set as a z direction.

In FIGS. 2 to 4, the arrow (broken line) in the λ/2 plate 18 indicates the slow axis 18s of the λ/2 plate 18 as described above. The slow axis 18s of the λ/2 plate 18 has an angle of 45° with respect to the vertical direction (x direction) and the horizontal direction (y direction).

In the LCD obtained by using the optical device 10, only the white light sources 12w are switched on without switching on the UV light sources 12u of the light source unit 12 in a case where image display is performed at a typical wide viewing angle.

As described above, in the optical device 10, the first composite film 16 and the second composite film 20 are in a state of not functioning in a case where the UV light sources 12u are switched off.

Therefore, white light emitted from the white light sources 12w, propagated by the light guide plate 14, and emitted from the main surface of the light guide plate 14 is transmitted through the first composite film 16, transmitted through the λ/2 plate 18, also transmitted through the second composite film 20, incident on the backlight side polarizing plate, and provided for image display by the liquid crystal display element of the LCD.

Accordingly, in this state, image display at a typical wide viewing angle is performed in the LCD. Further, since the first composite film 16 and the second composite film 20 are in a state of not functioning in a case where the UV light sources 12u are switched off, the light transmittance is high even in a case where the optical device includes the first composite film 16 and the second composite film 20.

Meanwhile, in a case where the UV light sources 12u are switched on, white light emitted from the white light sources 12w and ultraviolet light emitted from the UV light sources 12u are incident on the first composite film 16 and the second composite film 20.

As described above, in a case where the ultraviolet light is incident on the first composite film 16 and the second composite film 20, the optical characteristics of the photochromic material of the first composite film 16 and the second composite film 20 are changed. Due to the change in optical characteristics of this photochromic material, the light transmittance of the first composite film 16 and the second composite film 20 in the thickness direction (z direction) becomes smaller than the light transmittance in a direction orthogonal to the thickness direction.

In the case where the UV light sources 12u are switched on, the optical characteristics of the photochromic material are changed due to the incidence of ultraviolet light on the first composite film 16 and the second composite film 20 so that the first composite film 16 and the second composite film 20 enter the same state as the state in which an absorption axis is generated in the thickness direction (the alignment direction of the liquid crystal compound), that is, the z direction. Further, the generation of the absorption axis results in a state in which a transmission axis is generated in a direction orthogonal to the absorption axis.

Accordingly, in the case where the UV light sources 12u are switched on, the first composite film 16 and the second composite film 20 enter a state as in a polarizing plate whose absorption axis is allowed to coincide with the thickness direction.

Specifically, as conceptually illustrated in FIG. 3, in the case where the UV light sources 12u are switched on, the first composite film 16 and the second composite film 20 enter a state as in a polarizing plate Yp (two-dot chain line) which has an absorption axis a (an arrow indicated by the solid line) in the z direction, has a transmission axis ty (an arrow indicated by the broken line) in the y direction, and is in parallel with the z direction and the y direction, in a case where the LCD is observed at an elevation angle of 45° in the x direction.

Further, in the case where the UV light sources 12u are switched on, the first composite film 16 and the second composite film 20 enter a state as in a polarizing plate Xp which has an absorption axis a in the z direction, has a transmission axis tx in the x direction, and is in parallel with the z direction and the x direction, in a case where the LCD is observed at an elevation angle of 45° in they direction.

In a case where the LCD is observed from the x direction or the y direction in the state in which the UV light sources 12u are switched on, the first composite film 16, the λ/2 plate 18, and the second composite film 20 optically enter the state as illustrated in FIG. 4.

The absorption axis a generated in the first composite film 16 and the second composite film 20 in the state in which the UV light sources 12u are switched on is in the z direction, that is, the thickness direction. Therefore, in a case where the LCD is observed from the direction (z direction) orthogonal to the front surface, that is, the image display surface, the absorption axis a is almost in a state of not existing, in other words, the first composite film 16 and the second composite film 20 do not act as a polarizing plate.

Therefore, the image displayed by the LCD can be usually observed from the front surface.

In a case where the LCD is observed from the x direction, the first composite film 16 is in the same state as in the polarizing plate Yp which has the absorption axis a in the z direction (thickness direction) and the transmission axis ty in the y direction. Further, since the absorption axis a is in the z direction, in the case where the observation direction is the x direction, the action of the first composite film 16 as the polarizing plate Yp is increased as the value of the elevation angle is decreased.

Therefore, in the case where the LCD is observed from the x direction, the light to be transmitted through the first composite film 16 becomes linearly polarized light in the y direction due to the transmission axis ty of the polarizing plate Yp in the y direction.

The light turned into the linearly polarized light in the y direction by the first composite film 16 is incident on the λ/2 plate 18.

As described above, in a case where the LCD is observed from the x direction, the first composite plate 16 (polarizing plate Yp), the λ/2 plate 18, and the second composite plate 20 (polarizing plate Yp) are optically in the state as illustrated in FIG. 4.

Further, the λ/2 plate 18 is a λ/2 plate having a slow axis at an angle of 45° with respect to the y direction. Therefore, the linearly polarized light in the y direction which has been incident on the λ/2 plate 18 is rotated by 90° in the polarization direction by the λ/2 plate 18 and becomes linearly polarized light in the z direction.

The light turned into the linearly polarized light in the z direction by the λ/2 plate 18 is incident on the second composite film 20.

As described above, in a case where the LCD is observed from the x direction, the second composite film 20 is in the same state as in the polarizing plate Yp which has the absorption axis a in the z direction and the transmission axis ty in the y direction. Similar to the first composite film 16, in the case where the observation direction is the x direction, the action of the second composite film 20 as the polarizing plate Yp is increased as the value of the elevation angle is decreased.

Accordingly, the light turned into the linearly polarized light in the z direction by the λ/2 plate 18 is absorbed by the absorption axis a of the second composite film 20 (polarizing plate Yp), and thus is not provided for image display.

Consequently, in the state in which the UV light sources 12u are switched on, the image cannot be observed from the x direction. In other words, the viewing angle of the LCD in the x direction is narrowed by switching on the UV light sources 12u.

In a case where the LCD is observed from the y direction, the first composite film 16 is in the same state as in the polarizing plate Xp which has the absorption axis a in the z direction and the transmission axis tx in the x direction. Similar to the polarizing plate Yp, in the case where the observation direction is the y direction, the action of the first composite film 16 as the polarizing plate Xp is increased as the value of the elevation angle is decreased.

Therefore, in the case where the LCD is observed from the y direction, the light to be transmitted through the first composite film 16 becomes linearly polarized light in the x direction due to the transmission axis tx of the polarizing plate Xp in the x direction.

The light turned into the linearly polarized light in the x direction by the first composite film 16 is incident on the λ/2 plate 18.

As described above, in a case where the LCD is observed from the y direction, the first composite plate 16 (polarizing plate Xp), the λ/2 plate 18, and the second composite plate 20 (polarizing plate Xp) are optically in the state as illustrated in FIG. 4.

Further, the λ/2 plate 18 is a λ/2 plate having a slow axis at an angle of 45° with respect to the x direction. Therefore, the linearly polarized light in the x direction which has been incident on the λ/2 plate 18 is rotated by 90° in the polarization direction by the λ/2 plate 18 and becomes linearly polarized light in the z direction.

The light turned into the linearly polarized light in the z direction by the λ/2 plate 18 is incident on the second composite film 20.

As described above, in the case where the LCD is observed from the y direction, the second composite film 20 is in the same state as in the polarizing plate Xp which has the absorption axis a in the z direction and the transmission axis tx in the x direction. Similar to the first composite film 16, in the case where the observation direction is the y direction, the action of the second composite film 20 as the polarizing plate Xp is increased as the value of the elevation angle is decreased.

Accordingly, the light turned into the linearly polarized light in the z direction by the λ/2 plate 18 is absorbed by the absorption axis a of the second composite film 20 (polarizing plate Xp), and thus is not provided for image display.

Consequently, in the state in which the UV light sources 12u are switched on, the image cannot be observed from the y direction. In other words, the viewing angle of the LCD in the y direction is narrowed by switching on the UV light sources 12u.

In a case of this example, the light transmittance in the thickness direction becomes smaller than the light transmittance in a direction orthogonal to the thickness direction in a case where the image is observed from the x direction or the y direction.

This can be expressed as a difference in light transmittance between the elevation angle of 0° and the elevation angle of 45° in the x or y direction of the optical device according to the embodiment of the present invention.

A light transmittance ratio (Y0/Y45) is calculated by measuring the luminance Y0 at an elevation angle of 0° (front surface direction) and the luminance Y45 at an angle of 45° in white display using a measuring device “EZ-Contrast XL88” (manufactured by ELDIM).

The value of (Y0/Y45) is preferably 10 or greater, more preferably 100 or greater, and still more preferably 1000 or greater.

Even at the time of measuring the transmittance in a case of obtaining a polarizing film using one composite film, the difference in refractive index becomes the same value as in a case where two sheets of the composite films are used.

Further, the optical characteristics of the photochromic material of the first composite film 16 and the second composite film 20 are returned to the original state by switching off the UV light sources 12u, and the first composite film 16 and the second composite film 20 are in a state of not functioning before the UV light sources 12 are switched on. Therefore, image display at a typical wide viewing angle is performed.

Moreover, at the time of switching off the UV light sources 12u, the time for returning the optical characteristics of the photochromic material to the original state may be shortened by heating the first composite film 16 and the second composite film 20 and/or irradiating the first composite film 16 and the second composite film 20 with light having a wavelength different from the wavelength of the ultraviolet light.

As described above, according to the optical device and the LCD obtained by using this optical device, it is possible to switch between image display at a typical wide viewing angle and image display at a narrow viewing angle obtained by narrowing the viewing angle in the x direction and the y direction with a simple operation of switching on and off the UV light sources 12u.

Further, the configuration of the LCD is a simple configuration formed by adding only the UV light sources 12u, the first composite film 16, the λ/2 plate 18, and the second composite film 20.

According to a most preferred aspect, the optical device 10 illustrated in FIGS. 1 and 2 has a configuration in which the λ/2 plate 18 is interposed between the first composite film 16 and the second composite film 20, which contain a liquid crystal compound aligned in the thickness direction and a photochromic material and in which the optical characteristics of the photochromic material are changed by irradiation with ultraviolet rays so that the light transmittance in the thickness direction becomes smaller than the light transmittance in a direction orthogonal to the thickness direction.

In addition to this, the optical device 10 may also have a configuration obtained by changing the second composite film 20 to a polarizing film having an absorption axis in the thickness direction. Further, the positional relationship between the first composite film 16 and the second composite film 20 may be reversed as described above.

Such an example is conceptually illustrated in FIG. 5. Further, in an optical device 26 illustrated in FIG. 5, the same members are denoted by the same reference numerals as in the optical device illustrated in FIG. 1 and the like, and different members will be mainly described below.

The optical device 26 illustrated in FIG. 5 has a configuration obtained by changing the second composite film 20 to a polarizing film 28 in the optical device 10 illustrated in FIG. 1 and the like. In other words, the optical device 26 illustrated in FIG. 5 has a configuration in which the first composite film 16 is provided between the light guide plate 14 and the λ/2 plate 18 and the λ/2 plate 18 is interposed between the first composite film 16 and the polarizing film 28.

However, in the present invention, the positional relationship between the first composite film 16 and the second composite film 20 may be reversed as described above. Accordingly, the optical device according to the embodiment of the present invention may have a configuration in which the polarizing film 28 is provided between the light guide plate 14 and the λ/2 plate 18 and the λ/2 plate 18 is interposed between the polarizing film 28 and the first composite film 16.

Basically, any configuration may be employed in the present invention, but the configuration in which the first composite film 16 is provided between the light guide plate 14 and the λ/2 plate 18 is advantageous from the viewpoints of improving the efficiency of changing the optical characteristics of the photochromic material using ultraviolet light and suppressing deterioration of the photochromic material using ultraviolet light.

As described above, the polarizing film 28 is a polarizing film having an absorption axis in the thickness direction.

In the present invention, the expression “the polarizing film 28 has an absorption axis in the thickness direction” means that the angle of the absorption axis of the polarizing film 28 is in a range of 80° to 90° with respect to the film surface (the main surface (maximum surface)) of the polarizing film 28. Further, it is preferable that the polarizing film 28 has an absorption axis at an angle of 85° to 90° and most preferable that the polarizing film 28 has an absorption axis aligned perpendicularly (90°) to the film surface of the polarizing film 28.

The fact that the polarizing film 28 has an absorption axis in the thickness direction can be confirmed according to the following method. In other words, a transmittance T of the polarizing film 28 is measured by changing a polar angle θ by 10° in a range of −50° to 50° using AxoScan OPMF-1 (manufactured by OPTO SCIENCE, INC.). In a case where the polar angle with the maximum transmittance is set as θ0° in this measurement, “90°-θ0° ” becomes the “angle of the absorption axis”. Accordingly, in this manner, it is possible to confirm whether the polarizing film 28 has an absorption axis in the thickness direction.

Further, the polar angle θ is an angle of the polarizing film 28 with respect to the vertical line of the film surface thereof.

The configuration of the polarizing film 28 is not particularly limited as long as the polarizing film 28 has an absorption axis in the thickness direction. Among examples of the polarizing film, the polarizing film 28 which contains a birefringent material (a material having birefringence) and in which the birefringent material is aligned in a predetermined direction is preferable. More specifically, for example, in a case where a dichroic coloring agent described below is used as the birefringent material, the long axis of the dichroic coloring agent is disposed to be in parallel with the thickness direction of the polarizing film 28.

As such a polarizing film 28, for example, a polarizing film described in JP2008-165201A can be used.

The birefringent material is not particularly limited and can be appropriately selected according to the purpose thereof. Examples thereof include inorganic particles, dichroic coloring agents, anisotropic metal nanoparticles, carbon nanotubes, and metal complexes. Among these, dichroic coloring agents, anisotropic metal nanoparticles, and carbon nanotubes are particularly preferable.

Dichroic Coloring Agent

Examples of the dichroic coloring agent include an azo-based coloring agent and an anthraquinone-based coloring agent. These may be used alone or in combination of two or more kinds thereof.

In the present invention, the dichroic coloring agent is defined as a compound having a function of absorbing light. The maximum absorption and the absorption band of the dichroic coloring agent are not limited, but a dichroic coloring agent having a maximum absorption in a yellow region (Y), a magenta region (M), or a cyan region (C) is preferable. Further, two or more kinds of dichroic coloring agents may be used. Further, it is preferable that a mixture of dichroic coloring agents respectively having a maximum absorption in Y, M, and C is used and more preferable that dichroic coloring agents are mixed such that absorption can be made in the entire visible range (400 to 750 nm) and used. Here, the yellow region is in a range of 420 to 490 nm, the magenta region is in a range of 495 to 570 nm, and the cyan region is in a range of 620 to 750 nm.

Here, a chromophore used for the dichroic coloring agent will be described. The chromophore of the dichroic coloring agent is not particularly limited and can be appropriately selected according to the purpose thereof. Examples thereof include an azo coloring agent, an anthraquinone coloring agent, a perylene coloring agent, a merocyanine coloring agent, an azomethine coloring agent, a phthaloperylene coloring agent, an indigo coloring agent, an azulene coloring agent, a dioxazine coloring agent, a polythiophene coloring agent, and a phenoxazine coloring agent. Among these, an azo coloring agent, an anthraquinone coloring agent, or a phenoxazine coloring agent is preferable, and an anthraquinone coloring agent or a phenoxazine coloring agent (phenoxazine-3-one) is more preferable.

Further, specific examples of the coloring agent include the coloring agents described in paragraphs 0022 to 0075 of JP2008-275976A, and the contents of which are incorporated herein by reference.

Anisotropic Metal Nanoparticles

Anisotropic metal nanoparticles are nano-sized rod-like metal fine particles having a diameter of several nanometers to 100 nm. The rod-like metal fine particles indicate particles having an aspect ratio (length of long axis/length of short axis) of 1.5 or greater.

Such anisotropic metal nanoparticles exhibit surface plasmon resonance and exhibit absorption in the ultraviolet to infrared region. For example, since the anisotropic metal nanoparticles having a short axis length of 1 to 50 nm, a long axis length of 10 to 1000 nm, and an aspect ratio of 1.5 or greater are capable of changing the absorption position in the short axis direction and the long axis direction, a polarizing film obtained by aligning such anisotropic metal nanoparticles in an oblique direction with respect to the horizontal plane of the film becomes an anisotropic absorbing film.

Carbon Nanotubes

A carbon nanotube is elongated tubular carbon having a fiber diameter of 1 to 1000 nm, a length of 0.1 to 1000 μm, and an aspect ratio of 100 to 10000. Examples of a known method of preparing carbon nanotubes include an arc discharge method, a laser evaporation method, a thermal CVD method, and a plasma CVD method. Carbon nanotubes obtained using an arc discharge method and a laser evaporation method are divided into single wall nanotubes (SWNT) with only one graphene sheet and multi wall nanotubes (MWNT) with a plurality of graphene sheets.

Further, in a case where a thermal CVD method and a plasma CVD method are used, MWNT can be mainly prepared. SWNT has a structure in which one graphene sheet formed by connecting carbon atoms using a strongest bond referred to as an SP2 bond in a hexagonal shape is wound into a tubular shape.

The content of the birefringent material in the polarizing film 28 is preferably in a range of 0.1% to 90.0% by mass and more preferably in a range of 1.0% to 30.0% by mass. In a case where the content of the birefringent material is 0.1% by mass or greater, the polarizability can be sufficiently obtained. Meanwhile, in a case where the content thereof is 90% by mass or less, the polarizing film can be formed without any trouble and the transmittance of the polarizing film can be maintained.

The polarizing film 28 contains other components such as a dispersant, a solvent, and a binder resin in addition to the birefringent material depending on the method of forming the polarizing film (alignment method).

<<Method of Producing Polarizing Film>>

A method of producing the polarizing film 28 is not particularly limited as long as the absorption axis can be aligned in the substantially vertical direction with respect to the surface of the base material (the surface of the polarizing film) and can be appropriately selected according to the purpose thereof. Examples thereof include a metal nanorod deposition method in a liquid crystal alignment field (1); a guest-host liquid crystal method (2); and an anodized alumina method (3). Among these, a guest-host liquid crystal method is particularly preferable.

Examples of the method include the methods described in paragraphs 0087 to 0108 of JP2008-275976A, and the contents of which are incorporated herein by reference.

The thickness of the polarizing film 28 is not particularly limited and can be appropriately selected according to the purpose thereof. Further, the thickness thereof is preferably in a range of 0.1 to 10 μm and more preferably in a range of 0.3 to 3 μm.

As described above, the polarizing film 28 is a polarizing film having an absorption axis in the thickness direction. Such a polarizing film 28 has the same optical characteristics as those of the first composite film 16 and the second composite film 20 irradiated with ultraviolet rays.

In other words, the polarizing film 28 constantly has the absorption axis a in the z direction (thickness direction) and is in the same state as in the polarizing plate Yp which has the transmission axis ty in the y direction (horizontal direction) and is in parallel with the z direction and the y direction in a case of being viewed from the x direction (vertical direction). Further, the polarizing film 28 constantly has the absorption axis a in the z direction and is in the same state as in the polarizing plate Xp which has the transmission axis tx in the x direction and is in parallel with the z direction and the x direction in a case of being viewed from the y direction (see FIGS. 3 and 4).

Further, since the polarizing film 28 has a transmission axis in the z direction, the polarizing film 28 is in the same state of not functioning as in the first composite film 16 and the second composite film 20 in a case of being viewed from the front surface.

Therefore, in the state in which the UV light sources 12u are not switched on in such an optical device 26, since the first composite film 16 is in a state of not functioning, the light emitted from the light guide plate 14 is transmitted through the first composite film 16 and the λ/2 plate 18 and is incident on the polarizing film 28.

The polarizing film 28 is in a state of not functioning in a case of being viewed from the front surface. In addition, light is transmitted through the transmission axis ty of the polarizing plate Yp in the y direction in a case where the polarizing film 28 is viewed from the x direction, and light is transmitted through the transmission axis tx of the polarizing plate Xp in the x direction in a case where the polarizing film 28 is viewed from the y direction. Accordingly, in the state in which the UV light sources 12u are not switched on, typical image display can be performed.

In the case where the UV light sources 12u are switched on, the light transmittance of the first composite film 16 in the z direction becomes smaller than the light transmittance in a direction orthogonal to the z direction as described above. In other words, in the case where UV light sources 12u are switched on, the first composite film 16 is in the same state as in the polarizing plate Yp which has the absorption axis a in the z direction and the transmission axis ty in the y direction in a case of being viewed from the x direction and is in the same state as in the polarizing plate Xp which has the absorption axis a in the z direction and the transmission axis tx in the x direction in a case of being viewed from the y direction, as described above.

Therefore, similar to the above-described optical device 10 (LCD) illustrated in FIGS. 1 and 2, the viewing angle in the x direction and the y direction is narrowed by the action illustrated in FIGS. 3 and 4, and the image is displayed at a narrow viewing angle in the x direction and the y direction.

As described above, even in the optical device 26 illustrated in FIG. 5, it is possible to switch between image display at a typical wide viewing angle and image display at a narrow viewing angle obtained by narrowing the viewing angle in the x direction and the y direction with a simple operation of switching on and off the UV light sources 12u.

Further, the configuration of the LCD is a simple configuration formed by adding only the UV light sources 12u, the first composite film 16, the λ/2 plate 18, and the polarizing film 28.

The above-described example is an example in which the optical characteristics of the photochromic material are changed by irradiation with ultraviolet rays and the first composite film 16 functions as a polarizing plate having an absorption axis and a transmission axis, but the present invention is not limited thereto.

In other words, the present invention may employ the configuration in which the composite film is in a state of not functioning in a case where the optical characteristics of the photochromic material are changed by irradiation with ultraviolet rays, and the irradiation of ultraviolet rays is stopped and the optical characteristics of the photochromic material are returned to the original state, and the composite film functions as a polarizing plate having an absorption axis and a transmission axis in this state.

In the example illustrated in the figures, the backlight unit of the LCD is of an edge light type using the light guide plate 14, but the present invention is not limited thereto. In other words, in the present invention, a so-called direct type backlight unit that emits light from a light source to a liquid crystal display panel using a reflector or the like without using a light guide plate can also be used. At this time, for example, a light source emitting ultraviolet light or the like for changing the optical characteristics of the photochromic material may be disposed in the reflector of the direct type backlight unit together with the light source emitting light serving as a backlight.

Further, in the example illustrated in the figures, the light source unit 12 and the light guide plate 14 also have a backlight unit in the LCD and a light-emitting unit which emits light that changes the optical characteristics of the photochromic material in the optical device according to the embodiment of the present invention to the first composite film 16 or to the first composite film 16 and the second composite film 20, but the present invention is not limited thereto.

In other words, in the present invention, the backlight unit for display an image in the LCD and the light-emitting unit of the optical device which emits light for changing the optical characteristics of the photochromic material to the first composite film 16 or to the first composite film and the second composite film 20 may be separately provided. As an example, a configuration in which a direct type is employed as the backlight unit in the LCD, an edge light type is employed as the light-emitting unit that emits light for changing the optical characteristics of the photochromic material, and the light guide plate constituting the light-emitting unit of the optical device is disposed on the light emitting surface of the direct type backlight unit is exemplified.

Further, the above-described example is an example in which the optical device according to the embodiment of the present invention is incorporated in the liquid crystal display device, but the optical device according to the embodiment of the present invention is not limited thereto.

In other words, the optical device according to the embodiment of the present invention may be a single optical device which includes a polarizing plate, a composite film, and a light-emitting unit emitting light that changes the optical characteristics of the photochromic material of the composite film to the composite film and is provided separately from the display device.

In a case where a single optical device constitutes one device, the light-emitting unit may be of an edge light type or direct type. In a case where an edge light type is employed as the light-emitting unit at this time, a typical light guide plate used for a backlight unit of an LCD can be used as the light guide plate.

As a single optical device separately provided from the display device, an optical device including a light-emitting unit which includes a light guide plate and a light source unit having a light source emitting ultraviolet light to the light guide plate; a first composite film; a λ/2 plate; and a second composite film is exemplified. In other words, this optical device has the same configuration as that of the optical device 10 in FIG. 1 except that the light source unit does not include the white light sources 12w.

Further, as another example, an optical device including a light-emitting unit which includes a light guide plate and a light source unit having a light source emitting ultraviolet light to the light guide plate; a first composite film; a λ/2 plate; and a polarizing film is exemplified. In other words, this optical device has the same configuration as that of the optical device 26 in FIG. 5 except that the light source unit does not include the white light sources 12w.

By placing this optical device on a display surface (observation surface) of a display device such as an LCD, an organic electroluminescence display device, or a plasma display device and performing the above-described action of switching on and off the light sources of the light source unit, it is possible to switch between image display at a typical wide viewing angle in a state in which the light sources of the light source unit are switched off and image display at a narrow viewing angle in a state in which the light sources of the light source unit are switched on.

Hereinbefore, the optical device and the display device according to the embodiment of the present invention have been described in detail, but the present invention is not limited to the examples described above and various improvements or modifications can be made within the range not departing from the scope of the present invention.

### EXAMPLES

The features of the present invention will be described in detail with reference to the following examples. The materials, the reagents, the used amounts, the amounts of substances, the ratios, the treatment contents, and the treatment procedures described in the following examples can be appropriately changed within the range not departing from the gist of the present invention. Therefore, the range of the present invention should not be limitatively interpreted by the following specific examples.

### Example 1

<Preparation of Film 01>

The following materials were put into a mixing tank and stirred while being heated so that each component was dissolved, thereby preparing a cellulose acetate solution (dope) with the following composition.

<<Composition of Dope>>

Cellulose acetate (acetyl substitution degree of 2.86). . . 100 parts by mass

Triphenyl phosphate . . . 8 parts by mass

Biphenyl diphenyl phosphate . . . 4 parts by mass

Methylene chloride . . . 369 parts by mass

Methanol . . . 80 parts by mass

1-Butanol . . . 4 parts by mass

The prepared dope was heated to 30° C. and allowed to pass through a casting geeser so that the dope was cast on a glass plate. The surface temperature of the glass was set to −5° C., and the space temperature of the entire casting portion was set to 15° C.

After the casting, the dope was allowed to stand for 1 minute, dried at 45° C. for 1 minute, and peeled off from the glass. Next, the resultant was dried at 110° C. for 5 minutes and further dried at 140° C. for 10 minutes, thereby obtaining a protective film having a thickness of 80 μm. This protective film was set as a film 01. This film 01 is used as the base material of the first composite film 16 and the second composite film 20.

<Formation of Acrylic Layer>

The following materials were put into a mixing tank, stirred, and filtered using a polypropylene filter having a pore diameter of 0.4 μm, thereby preparing a composition for forming an acrylic layer.

<<Composition for Forming Acrylic Layer>>

Compound A . . . 70 parts by mass

Compound B . . . 30 parts by mass

Isopropyl alcohol . . . 425 parts by mass

Methyl acetate . . . 142 parts by mass

Compound A: KAYARAD PET 30: manufactured by Nippon Kayaku Co., Ltd., a mixture of a compound with the following structure, the mass average molecular weight is 298, and the number of functional groups in one molecule is 3.4 (average).

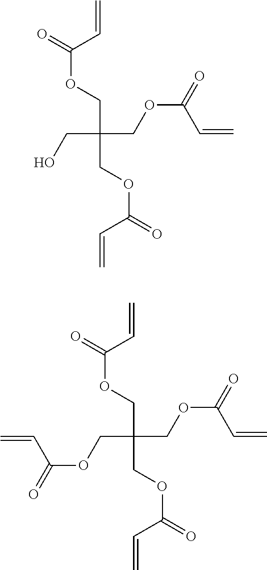

Compound B: BLEMMER GLM: manufactured by NOF CORPORATION, a compound with the following structure

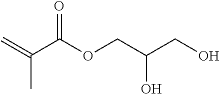

4% by mass of a photopolymerization initiator (IRGACURE 127, manufactured by BASF SE) was added to the prepared composition for forming an acrylic layer with respect to the solid content in the composition for forming an acrylic layer.

Next, the film 01 prepared in advance was coated with the composition for forming an acrylic layer obtained by adding a photopolymerization initiator, using a gravure coater. The composition was dried at 100° C. and irradiated with ultraviolet rays having an illuminance of 400 mW/cm² and an irradiation dose of 150 mJ/cm² using an air-cooled metal halide lamp (manufactured by EYE GRAPHICS CO., LTD.) having an intensity of 160 W/cm while nitrogen purging such that the oxygen concentration was set to 1.0% by volume or less so that the coating layer was cured, thereby forming an acrylic layer on the film 01. The thickness of the acrylic layer was 0.3 μm. This acrylic layer is formed into a vertical alignment film in the first composite film 16 and the second composite film 20.

<Preparation of First Composite Film 16 and Second Composite Film 20>

A liquid crystal composition for forming the first composite film 16 and the second composite film 20 containing a photochromic material and a liquid crystal compound with the following composition was prepared.

<<Liquid Crystal Composition for Forming First Composite Film 16 and Second Composite Film 20>>

Mixture of B01 and B02 . . . 100 parts by mass

S1 . . . 1 part by mass

S2 . . . 0.5 parts by mass

S3 . . . 0.8 parts by mass

Photochromic material mixture shown below . . . 3 parts by mass

Photopolymerization initiator (IRGACURE 907, manufactured by BASF SE) . . . 3 parts by mass

Sensitizer (KAYACURE DETX, manufactured by Nippon Kayaku Co., Ltd.) . . . 1 part by mass

Methyl ethyl ketone (MEK) . . . 195 parts by mass

Cyclohexanone (anone) . . . 22 parts by mass

In this liquid crystal composition, B01 and B02 are respectively a liquid crystal compound, and S1, S2, and S3 are respectively the above-described air interface vertical aligning agent.

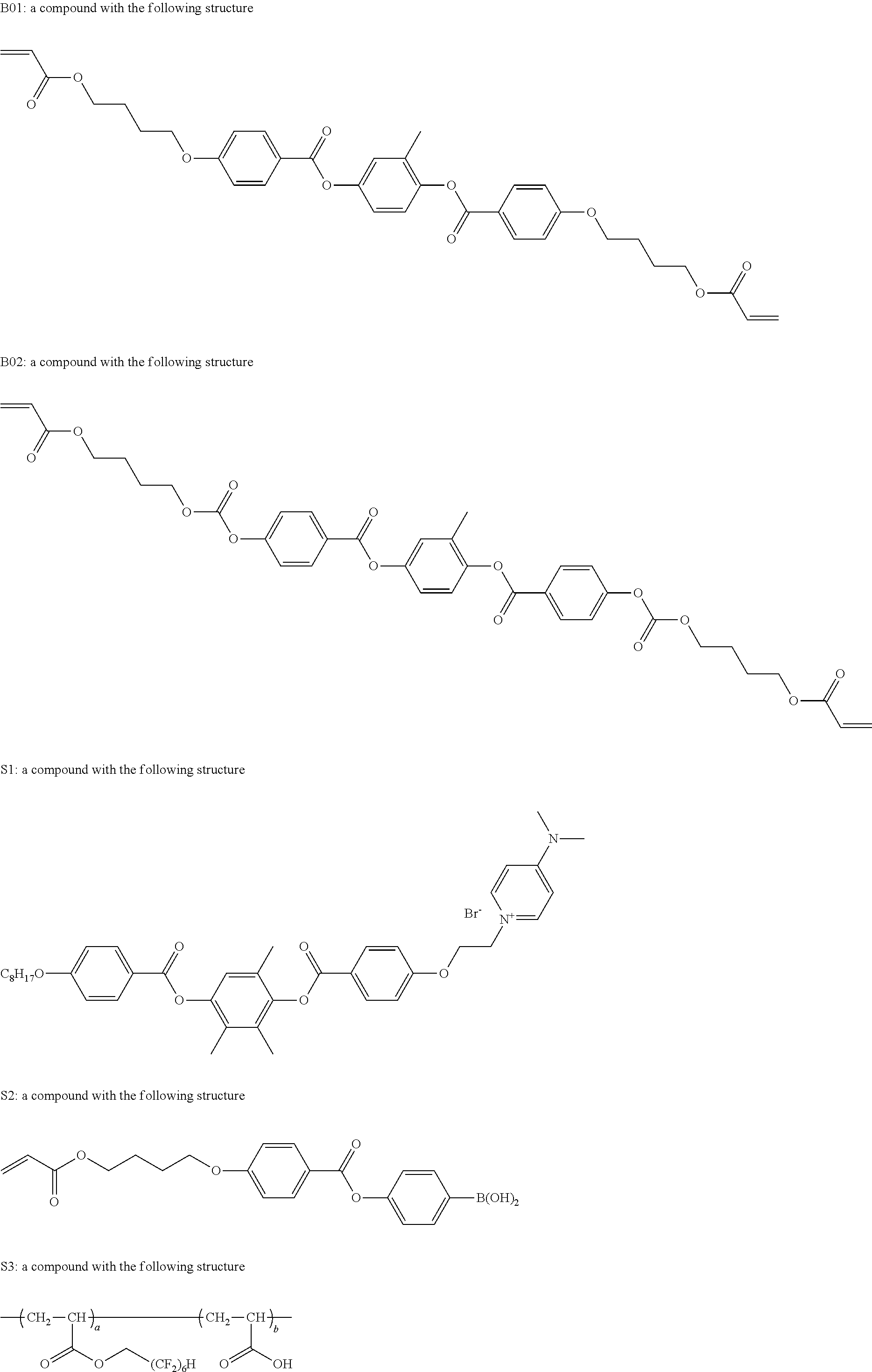

In the formulae shown above, a:b is 90:10 (mass ratio).

Mixture of photochromic materials: a mixture listed in the following table.

TABLE 1
Mixture of photochromic materials

| Photochromic material | Content in mixture (% by mass) |
|---|---|
| Photochromic A | 50 |
| Photochromic B | 30 |
| Photochromic C | 20 |

In the table shown above, the photochromic A indicates an indenonaphthopyran reported to generate a blue activation color.

The photochromic B indicates an indenonaphthopyran reported to generate a greenish activation color.

The photochromic C indicates an indenonaphthopyran reported to generate a reddish brown activation color.

The acrylic layer of the film 01 used to form an acrylic layer was coated with the prepared liquid crystal composition for forming the first composite film 16 and the second composite film 20 using a bar coater such that the coating amount thereof was set to 4 ml/m².

The composition was heated at a maturing temperature of 100° C. for 120 seconds and irradiated with ultraviolet rays with an illuminance of 600 mW/cm² for 4 seconds using an ultraviolet irradiation device (ultraviolet lamp: output of 160 W/cm, light emitting length of 1.6 m) while the temperature was maintained at 100° C., and the crosslinking reaction was promoted. Thereafter, the resultant was naturally cooled to room temperature, thereby obtaining an optical film. Two sheets of such optical films were prepared to obtain the first composite film 16 and the second composite film 20.

<Preparation of Alignment Film>

An alignment film coating solution with the following composition was prepared.

<<Alignment Film Coating Solution>>

Modified polyvinyl alcohol shown below . . . 10 parts by mass

Water . . . 370 parts by mass

Methanol . . . 120 parts by mass

Glutaraldehyde (crosslinking agent) . . . 0.5 parts by mass

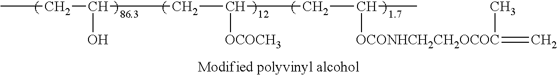

The surface of the film 01 was coated with 28 mL/m² of the prepared alignment film coating solution using a #16 wire bar coater. Thereafter, the surface was dried with hot air at 60° C. for 60 seconds and further dried with hot air at 90° C. for 150 seconds. The surface of the formed film was allowed to rotate at 1000 rev/min in a direction parallel to the transport direction using a rubbing roll to perform a rubbing treatment thereon, thereby preparing a film 01 provided with an alignment film.

<Preparation of λ/2 Plate 18>

The thickness of the film 01 provided with an alignment film was adjusted to form an optically-anisotropic layer, thereby preparing a λ/2 plate 18 with reference to the examples (<0272> to <0282>) of JP2012-018396A. Re (550) of the prepared λ/2 plate 18 was 274 nm.

An acrylic plate (thickness of 2 mm) was adhered to the surface of the first composite film 16 which had been coated with the liquid crystal composition using a pressure sensitive adhesive (SK DYNE, manufactured by Soken Chemical & Engineering Co., Ltd.). Further, similarly, the acrylic plate was adhered to the surface of the second composite film 20 which had been coated with the liquid crystal composition.

The λ/2 plate 18 was interposed between the first composite film 16 and the second composite film 20, to which the acrylic plate had been adhered, so that the λ/2 plate 18 was adhered thereto using a pressure sensitive adhesive (SK DYNE, manufactured by Soken Chemical & Engineering Co., Ltd.), thereby obtaining a laminate. At this time, the λ/2 plate 18 was prepared such that the slow axis thereof was in a direction of 45° with respect to the vertical direction and the horizontal direction of a screen of an iPad ((registered trademark), manufactured by APPLE Inc.) described below.

Next, the iPad was disassembled, the laminate of the first composite film 16, the λ/2 plate 18, and the second composite film 20 was disposed between the liquid crystal panel and the backlight, and ten pieces of UVLED (NSPU510US, manufactured by NICHIA CORPORATION) were equally arranged in a state of facing one end surface of the acrylic plate of the first composite film 16.

First, in a case where an image displayed on the iPad was observed in a state in which UVLED was not switched on, the image was able to be observed properly in a case of being observed from any oblique direction similar to a typical iPad.

Next, in a case where the screen of the iPad was visually observed from a direction of an elevation angle of 45° in the vertical direction (the x direction of FIG. 2) and the horizontal direction (the y direction of FIG. 2) in a state in which UVLED was switched on and the screen was irradiated with ultraviolet light, the image displayed on the iPad was not possible to see from any observation directions.

In a case where the image displayed on the iPad was observed after five minutes from when UVLED was switched off, the image was able to be observed properly in a case of being observed from any oblique direction similar to a typical iPad and to the observation performed before UVLED was switched on.

Here, Y0/Y45 measured using “EZ-Contrast XL88” after UVLED was switched on was greater than 10 in all directions, but Y0/Y45 measured after 5 minutes from when UVLED was switched off was approximately 3 to 4 in all directions.

### Example 2

<Preparation of Polarizing Film 01>

1.11 g of an initiator solution [a solution obtained by dissolving 0.90 g of IRGACURE 907 (manufactured by BASF SE) and 0.30 g of KAYACURE DETX (manufactured by Nippon Kayaku Co., Ltd.) in 8.80 g of methyl ethyl ketone (MEK)] was added to a liquid crystal solution obtained by dissolving 3.04 g of a liquid crystal compound (PALIOCOLOR LC242 (trade name), manufactured by BASF SE) containing a photopolymerizable group and 0.1 g of a polymeric surfactant (MEGAFACE F780F, manufactured by DIC Corporation) in 5.07 g of methyl ethyl ketone (MEK), and the solution was stirred for 5 minutes for complete dissolution.

Next, 0.023 g of a dichroic azo coloring agent G241 (manufactured by HAYASHIBARA CO., LTD.) and 0.005 g of a dichroic azo coloring agent G472 (manufactured by HAYASHIBARA CO., LTD.) were added to the obtained solution and subjected to ultrasonic dispersion for 5 minutes, thereby preparing a polarizing film coating solution.

<Formation of Acrylic Layer>

The following materials are put into a mixing tank, stirred, and filtered using a polypropylene filter having a pore diameter of 0.4 μm, thereby preparing a composition for forming an acrylic layer.

<<Composition for Forming Acrylic Layer>>

Compound A . . . 70 parts by mass

Compound B . . . 30 parts by mass

Isopropyl alcohol . . . 425 parts by mass

Methyl acetate . . . 142 parts by mass

Compound A: KAYARAD PET 30: manufactured by Nippon Kayaku Co., Ltd., a mixture of a compound with the following structure, the mass average molecular weight is 298, and the number of functional groups in one molecule is 3.4 (average).

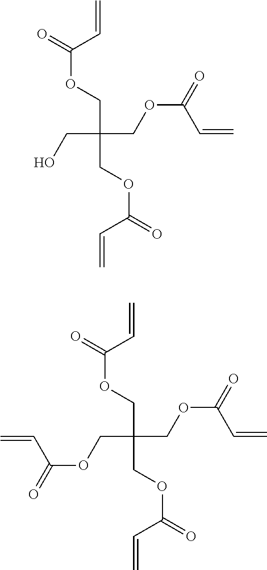

Compound B: BLEMMER GLM: manufactured by NOF CORPORATION, a compound with the following structure

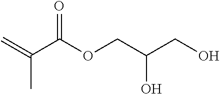

4% by mass of a photopolymerization initiator (IRGACURE 127, manufactured by BASF SE) was added to the prepared composition for forming an acrylic layer with respect to the solid content in the composition for forming an acrylic layer.

Next, the same film 01 as in Example 1 was coated with the composition for forming an acrylic layer obtained by adding a photopolymerization initiator, using a gravure coater. The composition was dried at 100° C. and irradiated with ultraviolet rays having an illuminance of 400 mW/cm² and an irradiation dose of 150 mJ/cm² using an air-cooled metal halide lamp (manufactured by EYE GRAPHICS CO., LTD.) having an intensity of 160 W/cm while nitrogen purging such that the oxygen concentration was set to 1.0% by volume or less so that the coating layer was cured, thereby forming an acrylic layer on the film 01. The thickness of the acrylic layer was 0.3 μm. This acrylic layer is formed into a vertical alignment film.

The acrylic layer of the film 01 used to form an acrylic layer was coated with the prepared polarizing film coating solution using a bar coater such that the coating amount thereof was set to 4 ml/m².

The film was heated at a maturing temperature of 180° C. for 120 seconds and irradiated with UV (50 mW, 300 mJ/cm²) using an ultraviolet irradiation device (mercury xenon lamp) while the temperature was maintained at 25° C., and the crosslinking reaction was promoted, thereby obtaining an optical film. This film was set as a polarizing film 01.

A laminate was prepared in the same manner as in Example 1 except that the polarizing film 01 was used in place of the second composite film 20 in the laminate of the first composite film 16, the λ/2 plate 18, and the second composite film 20, prepared in Example 1.

This laminate was disposed between the liquid crystal panel and the backlight of the iPad disassembled in the same manner as in Example 1, and UVLED was disposed in the same manner as in Example 1.

First, similar to Example 1, in a case where an image displayed on the iPad was observed in a state in which UVLED was not switched on, the image was able to be observed properly in a case of being observed from any oblique direction similar to a typical iPad.

Next, in a case where the screen of the iPad was visually observed from a direction of an elevation angle of 45° in the vertical direction (the x direction of FIG. 2) and the horizontal direction (the y direction of FIG. 2) in a state in which UVLED was switched on and the screen was irradiated with ultraviolet light, the image displayed on the iPad was not possible to see from any observation directions.

In a case where the image displayed on the iPad was observed after five minutes from when UVLED was switched off, the image was able to be observed properly in a case of being observed from any oblique direction similar to a typical iPad and to the observation performed before UVLED was switched on.

Here, Y0/Y45 measured using “EZ-Contrast XL88” after UVLED was switched on was greater than 10 in all directions, but Y0/Y45 measured after 5 minutes from when UVLED was switched off was approximately 3 to 4 in all directions.

Based on the description above, the effects of the present invention are evident.

The present invention can be suitably applied to tablet PCs, notebook PCs, smartphones, and the like.

### EXPLANATION OF REFERENCES

10, 26: optical device

12: light source unit

12w: white light source

12u: UV light source

14: light guide plate

16: first composite film

18: λ/2 plate

18s: slow axis

20: second composite film

28: polarizing film

Xp, Yp: polarizing plate

a: absorption axis

tx, ty: transmission axis

What is claimed is:

1. An optical device comprising:
a first composite film;
a second composite film or a polarizing film;
a λ/2 plate which is disposed between the first composite film and the second composite film or the polarizing film; and
a light-emitting unit,
wherein the first composite film and the second composite film contain a liquid crystal compound aligned in a thickness direction and a photochromic material, optical characteristics of the photochromic material are changed by irradiation with light, and a light transmittance of the first composite film and the second composite film in the thickness direction becomes smaller than a light transmittance in a direction orthogonal to the thickness direction,
the polarizing film has an absorption axis in the thickness direction, and
the light-emitting unit emits light that changes the optical characteristics of the photochromic material to the first composite film or to the first composite film and the second composite film.

2. The optical device according to claim 1,
wherein the polarizing film has a structure in which a birefringent material is aligned in the thickness direction.

3. The optical device according to claim 2,
wherein the birefringent material is a dichroic coloring agent.

4. The optical device according to claim 1,
wherein the light-emitting unit emits ultraviolet rays.

5. The optical device according to claim 2,
wherein the light-emitting unit emits ultraviolet rays.

6. The optical device according to claim 3,
wherein the light-emitting unit emits ultraviolet rays.

7. A display device comprising:
a display element; and
the optical device according to claim 1.

8. The display device according to claim 7,
wherein the display element is a liquid crystal display element.

9. The display device according to claim 8,
wherein the light-emitting unit of the optical device constitutes a backlight unit for allowing the liquid crystal display element to display an image.
